(19) United States
(12) Patent Application Publication
(10) Pub. No.: US 2017/0178015 A1
(43) Pub. Date: Jun. 22, 2017

(54) MAINTENANCE TIMING PREDICTION SYSTEM AND MAINTENANCE TIMING PREDICTION DEVICE

(71) Applicant: FANUC CORPORATION, Minamitsuru-gun (JP)

(72) Inventors: Shuji Sato, Minamitsuru-gun (JP); Mamoru Kubo, Minamitsuru-gun (JP); Koichi Murata, Minamitsuru-gun (JP)

(73) Assignee: FANUC CORPORATION, Minamitsuru-gun (JP)

(21) Appl. No.: 15/381,953

(22) Filed: Dec. 16, 2016

(30) Foreign Application Priority Data
Dec. 21, 2015 (JP) 2015-249021

(51) Int. Cl. G06N 7/00; G05B 19/4065

(52) U.S. Cl. CPC G06N 7/005; G05B 19/4065; G05B 2219/37209

(57) ABSTRACT

A data collecting processing part of a machine tool collects data indicating a state of a component at any time and sends the data. A maintenance timing prediction device has a collection data storing part that stores the data, a component replacement history storing part that stores a replacement history of the component, and a component lifetime prediction processing part that predicts a lifetime as the next replacement timing of the component. The component lifetime prediction processing part extracts data indicating a similar trend at the past replacement date of the component by referring to the component replacement history storing part and the collection data storing part, and predicts a threshold as data at the next replacement timing based on the latest replacement date of the component and the trend according to the extracted data, and predicts the lifetime based on the threshold.

### BACKGROUND OF THE INVENTION

1. Field of the Invention

The present invention relates to a maintenance timing prediction system and a maintenance timing prediction device, in particular to a technique to automatically predict maintenance timing of a component of a machine tool.

2. Description of the Related Art

Conventionally, a user detects a degradation state of a component of a machine tool, especially a component in which maintenance or replacement thereof should be frequently carried out in a regular inspection by using a measuring device, and then the user replaces the component which is determined to reach expiration of its lifetime.

In recent years, a system which automatically informs a user of timing of such a maintenance inspection has been provided. For example, JP 2015-026252 A discloses an abnormality detection device which detects abnormality of a vehicle precisely based on operational data of the vehicle.

JP 09-237103 A discloses a maintenance support system for an elevator. The system collects data including working condition or working frequency of the elevator to be maintained and stores the data in a database. Further, the system stores a failure phenomenon of the elevator and a countermeasure method against the failure phenomenon in a knowledge base in association with the working condition and the working frequency of the elevator. Then, the system predicts a countermeasure to be taken when the failure phenomenon is occurred on the elevator based on the database and the knowledge base with ranking of each failure phenomenon and each product .

JP 2014-174680 A discloses a numerical controller of a machine tool having a function which informs a user of timing of a component inspection to be carried out of each component used in the machine tool. The numerical controller reads inspection frequency, acquires an inspection date of the component and state quantity of the component, calculates a change amount of the state quantity, changes the inspection frequency when the change amount of the state quantity is more than a predetermined threshold, and informs a user of the next inspection date by calculating based on the latest inspection date and the inspection frequency when the state quantity is not more than the predetermined threshold.

In each of the configurations disclosed in JP 2015-026252 A, JP 09-237103 A, and JP 2014-174680 A, failure timing and inspection timing of the product or the component are predicted based on data regarding a working state of the machine, a rule and a threshold defined in advance and the like. However, in such configurations, operation to specify and set data to be collected, and the rule and the threshold used in the prediction in advance is necessary. Such an operation needs much man hours.

### SUMMARY OF THE INVENTION

An object of the present invention is, in order to solve the problem described above, to provide a maintenance timing prediction system and a maintenance timing prediction device capable of automatically predicting maintenance timing without determining data to be monitored, a threshold used in prediction or the like in advance.

A maintenance timing prediction system according to an embodiment of the present invention includes: a maintenance timing prediction device; and a plurality of machine tools, wherein the machine tool includes a data collecting processing part that collects data indicating a state of a component in the machine tool at any time and sends the data to the maintenance timing prediction device, the maintenance timing prediction device includes: a collection data storing part that stores the data; a component replacement history storing part that stores a replacement history of the component; and a component lifetime prediction processing part that predicts a lifetime as the next replacement timing of the component, the component lifetime prediction processing part extracts data indicating a similar trend at the past replacement date of the component by referring to the component replacement history storing part and the collection data storing part, the component lifetime prediction processing part predicts a threshold as data at the next replacement timing based on the latest replacement date of the component according to the extracted data and the trend, and the component lifetime prediction processing part predicts the lifetime based on the threshold.

In the maintenance timing prediction system according to another embodiment, the component lifetime prediction processing part calculates a warning lifetime value as a predicted value of the data at predetermined days before the lifetime, and the maintenance timing prediction system includes a display part that shows a warning when the data received from the data collecting processing part reaches the warning lifetime value.

In the maintenance timing prediction system according to another embodiment, the component lifetime prediction processing part extracts the data in which a change amount of the data between a plurality of the past replacement dates is within a predetermined error range as the data indicating the similar trend, and the component lifetime prediction processing part extracts the data when a number of the change amount within the predetermined error range exceeds a specific number or a specific probability.

In the maintenance timing prediction system according to another embodiment, the component lifetime prediction processing part extracts the data at a plurality of the past replacement dates within a predetermined error range as the data indicating the similar trend, and the component lifetime prediction processing part extracts the data when a number of the data within the predetermined error range exceeds a specific number or a specific probability.

A maintenance timing prediction device according to another embodiment includes: a collection data storing part that collects and stores data indicating a state of a component in a machine tool at any time; a component replacement history storing part that stores a replacement history of the component; and a component lifetime prediction processing part that predicts a lifetime as the next replacement timing of the component, wherein the component lifetime prediction processing part extracts data indicating a similar trend at the past replacement date of the component by referring to the component replacement history storing part and the collection data storing part, the component lifetime prediction processing part predicts a threshold as data at the next replacement timing based on the latest replacement date of the component according to the extracted data and the trend, and the component lifetime prediction processing part predicts the lifetime based on the threshold.

According to the present invention, the maintenance timing prediction system and the maintenance timing prediction device capable of automatically predicting the maintenance timing without determining the data to be monitored, the threshold used in prediction or the like in advance can be provided.

### BRIEF DESCRIPTION OF THE DRAWINGS

The above and other objects and features of the present invention will become apparent from the following detailed description of embodiments made with reference to the accompanying drawings. In the drawings:

FIG. 1A is a flow chart illustrating an example of operation of a maintenance timing prediction system;

FIG. 1B is a flow chart illustrating an example of the operation of the maintenance timing prediction system;

FIG. 1C is a flow chart illustrating an example of the operation of the maintenance timing prediction system;

FIG. 1D is a flow chart illustrating an example of operation of the maintenance timing prediction system;

FIG. 2 is a diagram illustrating an example of a configuration of the maintenance timing prediction system;

FIG. 3A is a diagram illustrating one example of data extraction process of the maintenance timing prediction system;

FIG. 3B is a diagram illustrating one example of the data extraction process of the maintenance timing prediction system; and

FIG. 4 is a block diagram illustrating an example of the configuration of the maintenance timing prediction system.

### DETAILED DESCRIPTION OF THE PREFERRED EMBODIMENTS

Hereinafter, embodiments of the present invention are described with reference to drawings.

### Configuration

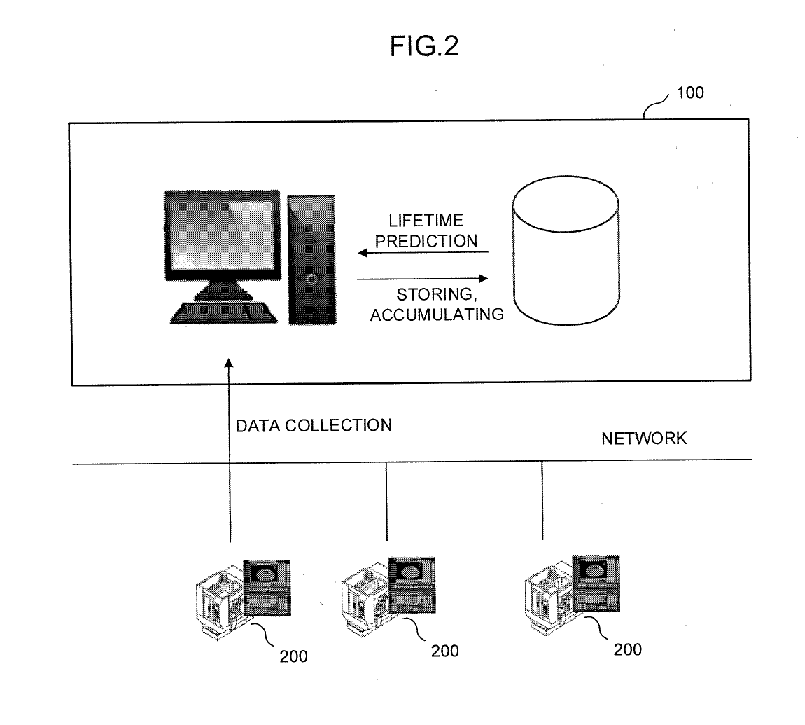

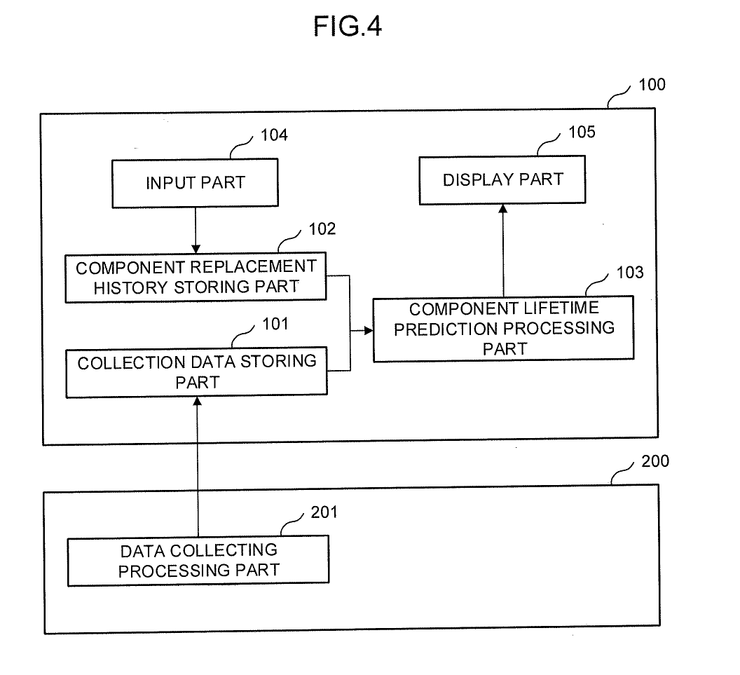

A maintenance timing prediction system according to the embodiment of the present invention is described with reference to FIG. 2 and FIG. 4. FIG. 2 is a diagram illustrating a schematic configuration of hardware of the maintenance timing prediction system. FIG. 4 is a block diagram illustrating a functional configuration of the maintenance timing prediction system.

As shown in FIG. 2, in the maintenance timing prediction system, a maintenance timing prediction device 100 and a plurality of machine tools 200 are connected to each other in a communicable manner via a network. The maintenance timing prediction device 100 is typically provided by a host computer. Further, the machine tool 200 is typically provided with a numerical controller. In the host computer and the numerical controller, a central information processing device (CPU) logically achieves various processing means by executing a predetermined process in accordance with a program stored in a storage device and by controlling each of the hardware or the like as needed.

As shown in FIG. 4, the maintenance timing prediction device 100 includes a collection data storing part 101, a component replacement history storing part 102, a component lifetime prediction processing part 103, an input part 104, and a display part 105. Further, the machine tool 200 includes a data collecting processing part 201.

The data collecting processing part 201 of the machine tool 200 collects data indicating a state of the machine tool 200 at regular intervals and sends the data to the maintenance timing prediction device 100.

The maintenance timing prediction device 100 receives the data from the data collecting processing part 201 and stores the data in the collection data storing part 101.

The input part 104 receives a replacement history of a component and stores the replacement history in the component replacement history storing part 102. Typically, when a component is determined to reach expiration of its lifetime and replaced, a maintenance person of the machine tool 200 inputs the replacement history of the component in the input part 104. The replacement history preferably includes a machine number, a component number, and a replacement date.

The component lifetime prediction processing part 103 extracts data indicating a similar trend at the past replacement timing by referring to the component replacement history storing part 102. Further, the component lifetime prediction processing part 103 predicts a value (threshold) of the data which is considered to be shown at the next replacement timing, and timing (lifetime) when the data reaches the threshold.

The display part 105 shows the lifetime predicted by the component lifetime prediction processing part 103. Further, the display part 105 shows a warning when the collecting data approaches the threshold.

### Operation

Next, operation of the maintenance timing prediction system is schematically described.

(1) Collecting data of a plurality of the machine tools 200 at regular intervals.

The maintenance timing prediction device 100 collects data indicating the state of the machine at regular intervals from a plurality of the machine tools 200 connected via a network. Here, the plurality of the machine tools 200 is formed as a same kind of the machine tool using a same kind of components. Further, a several kinds of the data including, for example, a axis total moving amount, a total cutting time, a fan rotation speed, battery voltage and the like can be collected from each of the machine tools 200. The maintenance timing prediction device 100 stores the data and the collection time thereof in the collection data storing part 101 in association with each other.

Further, when the component of the machine tool 200 is replace in the maintenance operation, the input part 104 receives the replacement history. The replacement history includes information such as the machine number, the component number, the replacement date and the like. The component replacement history storing part 102 stores the replacement history.

(2) Analyzing the data and extracting the data indicating a same trend at the past replacement timing of the component.

When a new replacement history is input, the component lifetime prediction processing part 103 extracts all of the replacement dates when the same component is replaced in the past in the plurality of the machine tools 200 by referring to the component replacement history storing part 102. Further, the component lifetime prediction processing part 103 reads all of the data right before the extracted replacement dates by referring to the collection data storing part 101. The component lifetime prediction processing part 103 analyses the extracted data and specifies the kind of the data indicating the same trend at the past replacement timing of the component among the extracted data.

The present inventor found that the data indicates two types of the trends. One type of the trends is that a change amount of the data between the replacement dates is always within a predetermined error range. Specifically, the data having the one type of the trends corresponds to the axis total moving amount, the total cutting time or the like. Another type of the trends is that a value acquired right before the replacement date is always within a predetermined error range. Specifically, the data having another type of the trends corresponds to the fan rotation speed, the battery voltage or the like.

Thus, the component lifetime prediction processing part 103 can extract a kind of the data, for example the change amount of the data between the past replacement dates which is always within the predetermined error range, or the value of the data right before the past replacement date which is always within the predetermined error range.

(3) Predicting threshold at the next expiration of the lifetime of the extracted data.

The component lifetime prediction processing part 103 predicts a value (threshold) of the data which is considered to be shown at the next replacement timing based on the trend indicated by the data extracted in (2) described above and the value of the present data.

For example, regarding the data in which the change amount between the past replacement dates is substantially constant, a threshold can be predicted as a value in which the value of the present data is added by the change amount. Further, regarding the data in which the value acquired right before the replacement date is substantially constant, a threshold can be predicted as the constant value (threshold).

(4) Predicting and showing the timing at the expiration of the lifetime. Showing the warning when the collecting data approaches the threshold.

The component lifetime prediction processing part 103 thereafter continues to monitor the collection data storing part 101 at any time and shows the predicted lifetime on the display part 105. Specifically, the component lifetime prediction processing part 103 thereafter monitors the storing data and calculates a change rate of the value of the data at any time. Then, the component lifetime prediction processing part 103 calculates the timing when the data reaches the threshold based on the value of the present data and the change rate.

Further, the component lifetime prediction processing part 103 shows the warning on the display part 105 when the collected data approaches the threshold.

In this way, the maintenance timing prediction system according to the present embodiment can automatically predict the next replacement timing and warn that the replacement timing is coming without determining a kind of the data or a threshold to be monitored in advance.

### Example

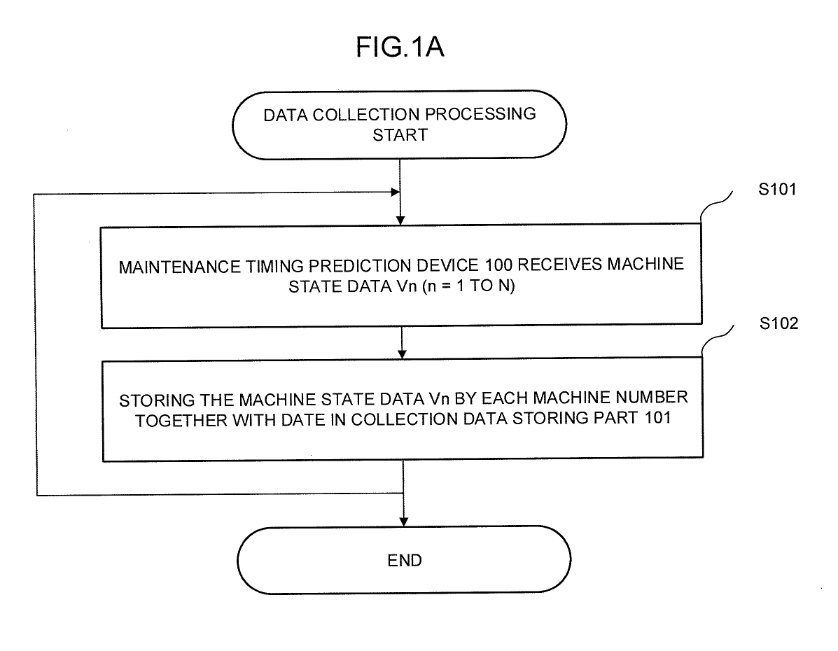

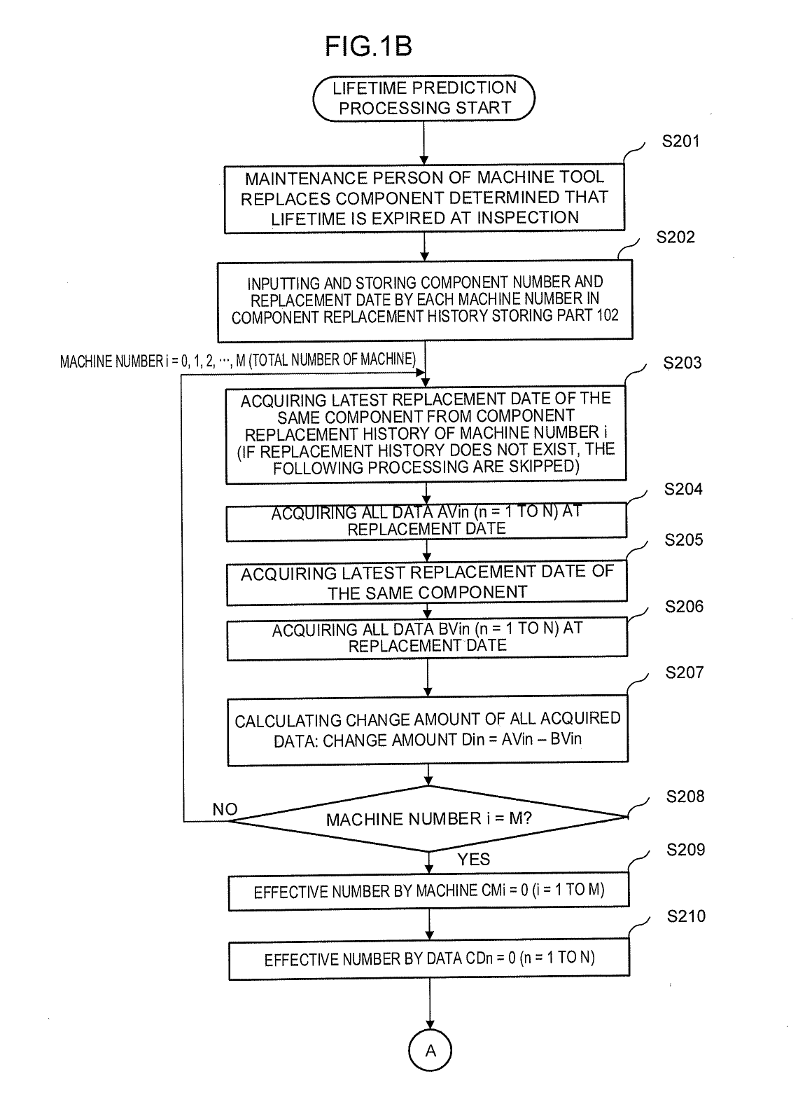

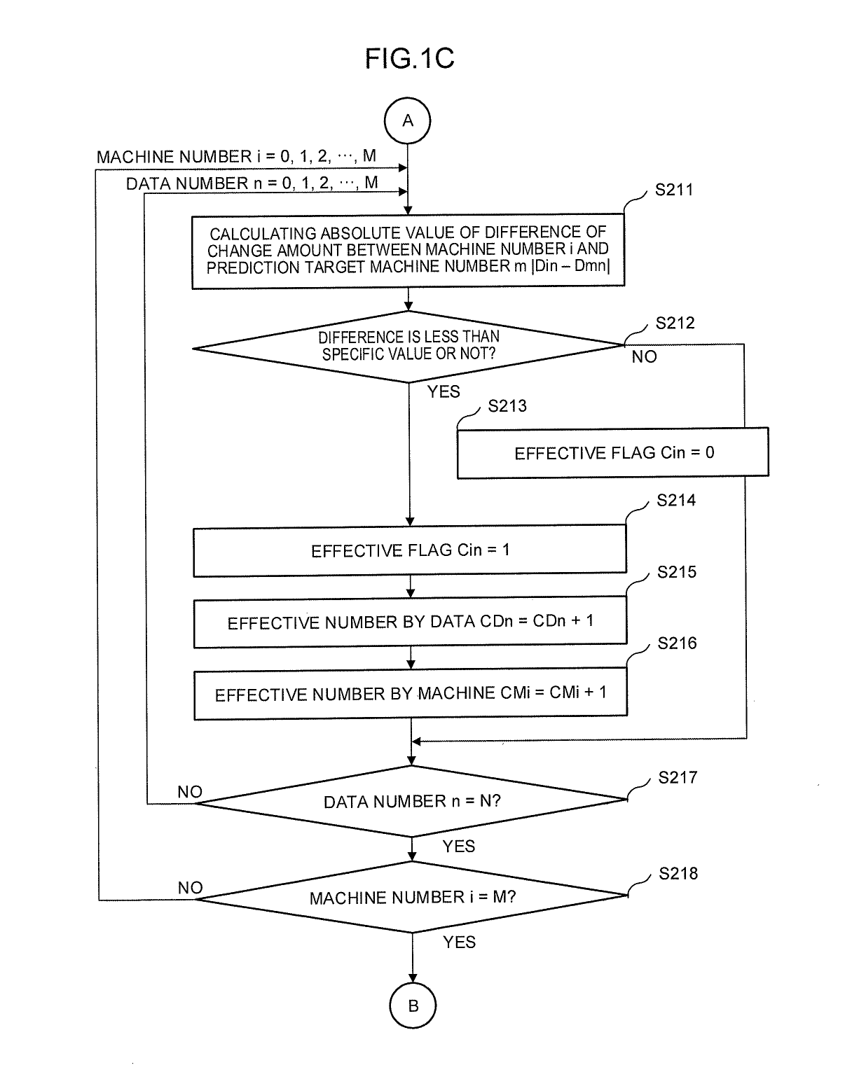

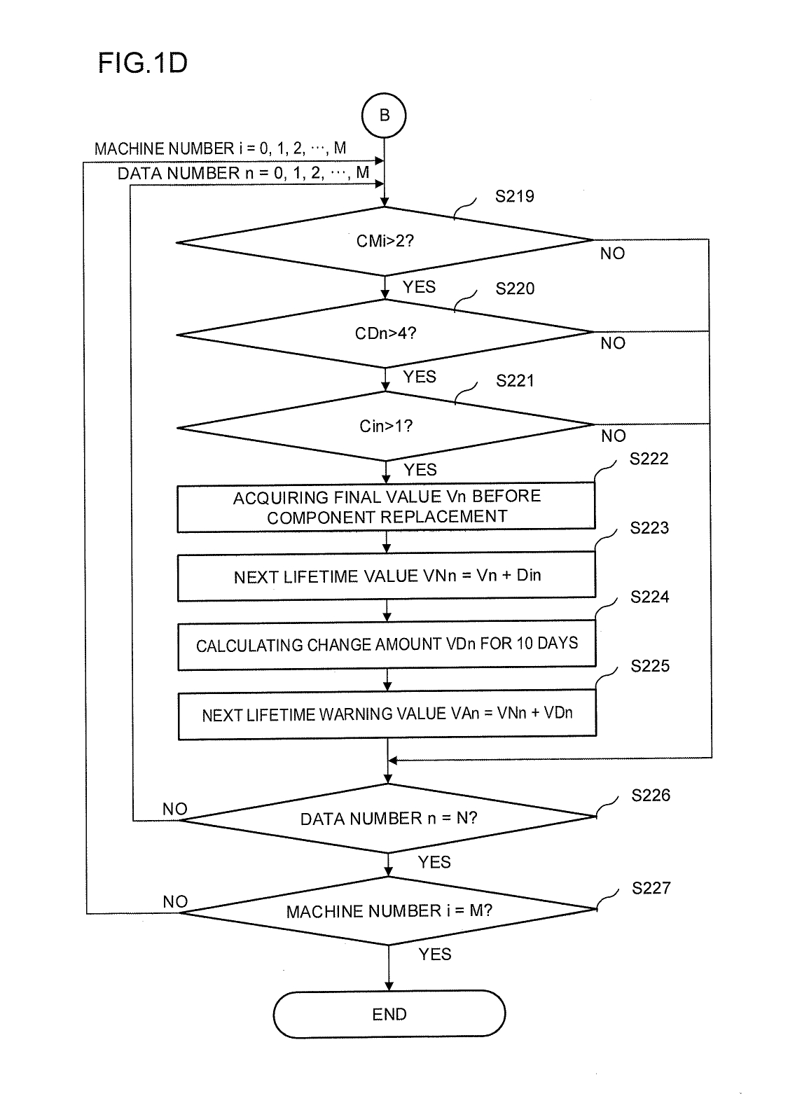

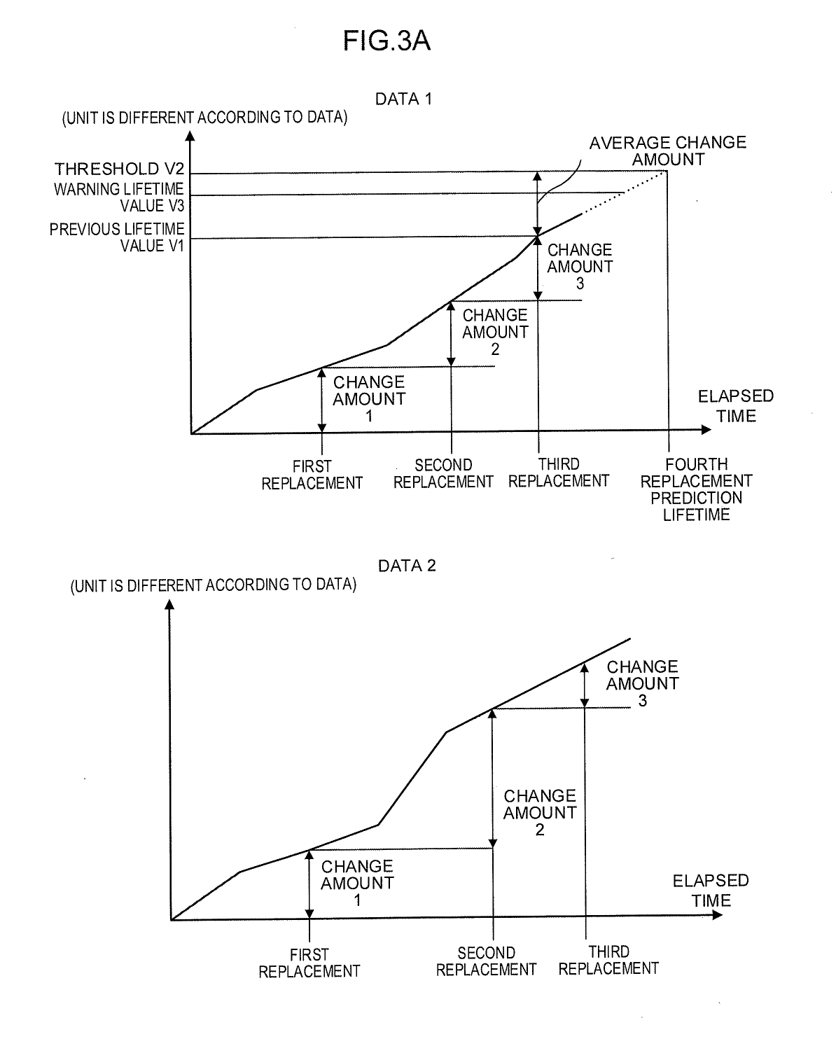

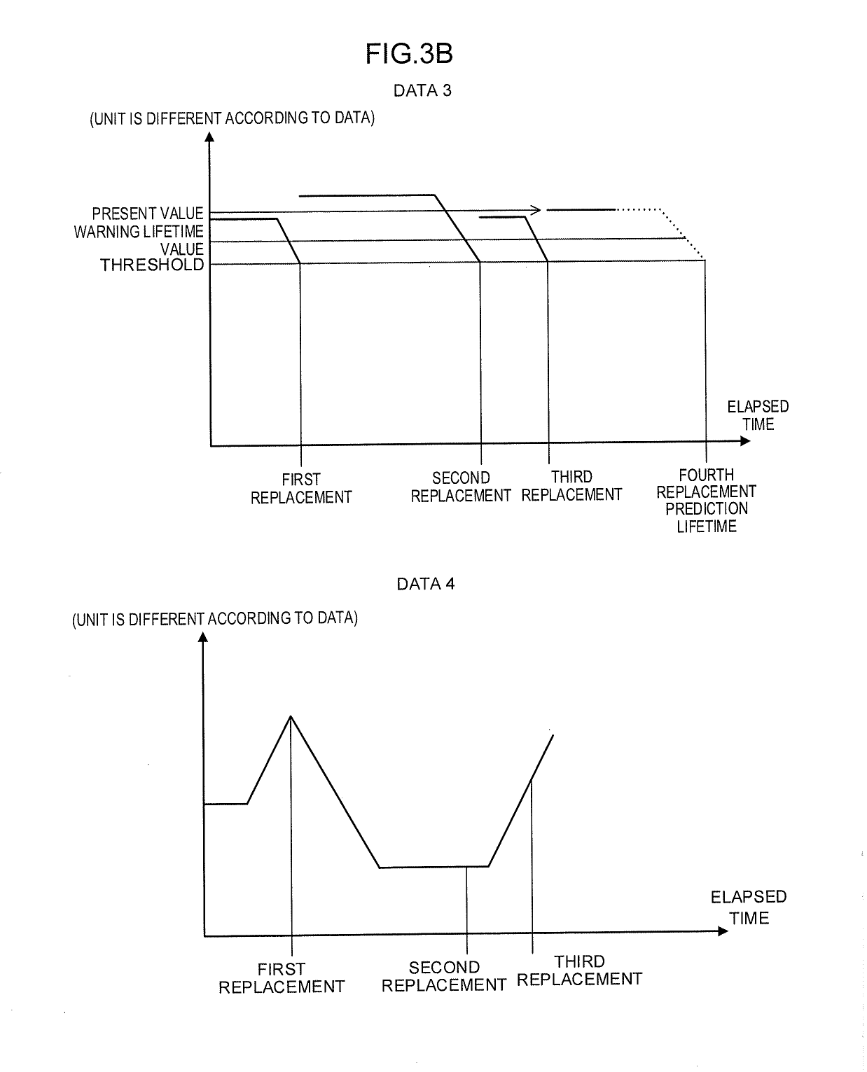

Next, an example of operation of the maintenance timing prediction system is described with reference to flow charts shown in FIGS. 1A to 1C and data shown in FIGS. 3A, 3B.

At first, a data collecting process is described. In the plurality of the machine tools 200, the data collecting processing part 201 collects the data indicating each of the states of the machines. The data collecting processing part 201 collects, for example, the axis total moving amount, the total cutting time, the fan rotation speed, the battery voltage or the like based on, for example, numerical information of a mechanical component such as a motor, or a value of the sensor. The data collecting processing part 201 sends the collected data to the maintenance timing prediction device 100 via the network. For example, the data collecting processing part 201 acquires and sends the data at every one second.

The maintenance timing prediction device 100 receives the data and temporarily stores the data in a memory (S101). Then, a value and a kind of the received data, a machine number, and a collection time or a receive time are combined as one record and stored in the collection data storing part 101 as a database in the storing device (S102).

Next, a lifetime prediction process is described. A maintenance person of the machine tool replaces the component which reaches the expiration of its lifetime at the inspection (S201). At this time, the maintenance person inputs the replacement history of the component in the input part 104 (S202). The replacement history includes the machine number, the component number, the replacement date and the like. The input replacement history is added as a new record into the component replacement history storing part 102 as the database in the storing device.

At this time, the component lifetime prediction processing part 103 extracts the past two replacement dates of the component as same as the component where the replacement history thereof is newly added by referring to the component replacement history storing part 102. In this process, the replacement dates with respect to all of the machine tools 200 are extracted. Further, when a number of the replacement in the replacement history is less than a specific number, the processing is ended.

The component lifetime prediction processing part 103 extracts each data right before the past two replacement dates by referring to the collection data storing part 101, and then the component lifetime prediction processing part 103 calculates a change amount of the two data, namely the differences between the two data. The component lifetime prediction processing part 103 sequentially calculates each of the change amounts of the data between the past replacement dates in a similar way. Further, the component lifetime prediction processing part 103 executes the similar process against the data of all of the machine tools 200 (S203 through S208).

Here, the component lifetime prediction processing part 103 judges whether the difference between the change amounts extracted from a certain machine is within a predetermined error range (for example, less than 10%). For example, in Data 1 shown in FIG. 3A, each of the change amounts of the data among three times of the component replacement is within ±10% as the specific error range. Namely, the change amount 1 the change amount 2 the change amount 3. Accordingly, it is determined that Data 1 is effective in the lifetime prediction in the future. On the other hand, in Data 2, the change amounts of the data among three times of the component replacement are not constant. Accordingly, it is determined that Data 2 is not effective in the lifetime prediction.

The component lifetime prediction processing part 103 executes the judgment of the effectiveness of the data against all of the machine tools 200 in the similar way. Then, the component lifetime prediction processing part 103 judges whether a number of the change amount determined as effective in all of the machine tools 200 exceeds a specific number or probability. In a case in which the number of the change amount determined as effective in all of the machine tools 200 exceeds a specific number or probability, it is determined at further higher accuracy that the data is effective in the lifetime prediction (S211 through S218).

Next, the component lifetime prediction processing part 103 acquires the data right before a plurality of the past replacement dates by referring to the collection data storing part 101. The component lifetime prediction processing part 103 executes the similar process against the data of all of the machine tools 200.

Here, the component lifetime prediction processing part 103 judges whether the difference between the data extracted from a certain machine is within a predetermined error range (for example, less than 10%). For example, in Data 3 shown in FIG. 3B, each of the values of the data among three times of the component replacement is within ±10% as the specific error range. Namely, the value 1≈the value 2≈the value 3. Accordingly, it is determined that Data 3 is effective in the lifetime prediction in the future. On the other hand, in Data 4, the values of the data among three times of the component replacement are not constant. Accordingly, it is determined that Data 4 is not effective in the lifetime prediction.

The component lifetime prediction processing part 103 executes the judgment of the effectiveness of the data against all of the machine tools 200 in the similar way. Then, the component lifetime prediction processing part 103 judges whether a number of the value determined as effective in all of the machine tools 200 exceeds a specific number or probability. In a case in which the number of the value determined as effective in all of the machine tools 200 exceeds a specific number or probability, it is determined at further higher accuracy that the data is effective in the lifetime prediction.

Next, the component lifetime prediction processing part 103 executes the lifetime prediction of the replacement component against the machine tool 200 in which the data determined as effective in the lifetime prediction is acquired. At first, the component lifetime prediction processing part 103 calculates a threshold by adding an average change amount of the data to the value of the data right before the latest replacement date.

Threshold=Average change amount+Value at the latest replacement

In an example of Data 1 shown in FIG. 3A, threshold V2=(change amount 1+change amount 2+change amount 3)/3+previous lifetime value V1.

Further, the component lifetime prediction processing part 103 calculates a warning lifetime vale for warning before the component reaches the expiration of its replacement lifetime. Then, the component lifetime prediction processing part 103 monitors the collection data, and when the data exceeds the warning lifetime value, the component lifetime prediction processing part 103 shows the warning on the display part 105 that the component lifetime is coming. For example, in a case in which the warning is made at a predetermined days before reaching the expiration of the lifetime, the warning lifetime value is calculated by the following formula.

Warning lifetime value=(A predetermined number of days/Average replacement interval days)×Average change amount+Value at the latest replacement

Further, the component lifetime prediction processing part 103 predicts the timing when the component reaches the expiration of the replacement lifetime and shows the predicted lifetime on the display part 105. The predicted lifetime is calculated by the following formula.

Predicted lifetime=((a present number of days elapsed since the latest replacement date)/(a present value of data−a value at the latest replacement))×(a threshold−the value at the latest replacement)+the latest replacement date

The component lifetime prediction processing part 103 executes the showing of the warning lifetime and the predicted lifetime described above against all of the data determined as effective in the lifetime prediction and all of the machine tools 200 in which the effective data is acquired, and then the processing is ended (S219 through S227).

According to the present embodiment, the maintenance timing prediction system achieves the following remarkable effects.

(1) Operation and setting to specify the collection data and the threshold in advance are not needed.

Since the component lifetime prediction processing part 103 automatically extracts the data effective in the lifetime prediction among collected many data, it is not necessary to specify the data to be used in the lifetime prediction in advance. Further, since the threshold at the next replacement and the timing of the next replacement are automatically predicted by using such data, it is not necessary to set a threshold.

(2) Inspection timing conforming to an actual condition can be informed and therefore unnecessary inspection can be eliminated.

The component lifetime prediction processing part 103 automatically predicts the lifetime conforming to the actual working condition of the machine tool 200 by means of the prediction processing. Thus, maintenance man hour for the regular inspection or the like can be reduced.

Further, the present invention is not limited to the embodiment described above, and modification such as replacement, omission, addition, exchange in order of components or the like can be adopted within a scope of the present invention.

1. A maintenance timing prediction system comprising:
a maintenance timing prediction device; and
a plurality of machine tools, wherein the machine tool includes a data collecting processing part that collects data indicating a state of a component in the machine tool at any time and sends the data to the maintenance timing prediction device,
the maintenance timing prediction device includes:
a collection data storing part that stores the data;
a component replacement history storing part that stores a replacement history of the component; and
a component lifetime prediction processing part that predicts a lifetime as the next replacement timing of the component,
the component lifetime prediction processing part extracts data indicating a similar trend at the past replacement date of the component by referring to the component replacement history storing part and the collection data storing part,
the component lifetime prediction processing part predicts a threshold as data at the next replacement timing based on the latest replacement date of the component according to the extracted data and the trend, and
the component lifetime prediction processing part predicts the lifetime based on the threshold.

2. The maintenance timing prediction system according to claim 1, wherein the component lifetime prediction processing part calculates a warning lifetime value as a predicted value of the data at predetermined days before the lifetime, and
the maintenance timing prediction system comprises a display part that shows a warning when the data received from the data collecting processing part reaches the warning lifetime value.

3. The maintenance timing prediction system according to claim 1, wherein the component lifetime prediction processing part extracts the data in which a change amount of the data between a plurality of the past replacement dates is within a predetermined error range as the data indicating the similar trend, and
the component lifetime prediction processing part extracts the data when a number of the change amount within the predetermined error range exceeds a specific number or a specific probability.

4. The maintenance timing prediction system according to claim 1, wherein the component lifetime prediction processing part extracts the data at a plurality of the past replacement dates within a predetermined error range as the data indicating the similar trend, and
the component lifetime prediction processing part extracts the data when a number of the data within the predetermined error range exceeds a specific number or a specific probability.

5. A maintenance timing prediction device comprising:
a collection data storing part that collects and stores data indicating a state of a component in a machine tool at any time;
a component replacement history storing part that stores a replacement history of the component; and
a component lifetime prediction processing part that predicts a lifetime as the next replacement timing of the component, wherein
the component lifetime prediction processing part extracts data indicating a similar trend at the past replacement date of the component by referring to the component replacement history storing part and the collection data storing part,
the component lifetime prediction processing part predicts a threshold as data at the next replacement timing based on the latest replacement date of the component according to the extracted data and the trend, and
the component lifetime prediction processing part predicts the lifetime based on the threshold.
